(19) United States
(12) Patent Application Publication
(10) Pub. No.: US 2015/0120450 A1
(43) Pub. Date: Apr. 30, 2015

(54) MEDIA CODE SYSTEMS AND METHODS

(71) Applicant: Douglas Tinkler, Atlanta, GA (US)

(72) Inventor: Douglas Tinkler, Atlanta, GA (US)

(21) Appl. No.: 14/524,710

(22) Filed: Oct. 27, 2014

Related U.S. Application Data
(60) Provisional application No. 61/895,650, filed on Oct. 25, 2013.

(51) Int. Cl. G06Q 30/02; G06Q 30/06

(52) U.S. Cl. CPC G06Q 30/0277; G06Q 30/0257; G06Q 30/0641
USPC 705/14.55; 705/14.73

(57) ABSTRACT

Media code systems and methods include a media code assigned to an advertisement. The media code is a mnemonic code associated with the advertisement. A server stores the media code and content relative to the media code. Computer software is in communication with the server for entering the media code and retrieving the content. Whereby, the media code system and method provides a means for consumers to interact with the advertisement.

### CROSS-REFERENCE TO RELATED APPLICATIONS

To the full extent permitted by law, the present United States Non-provisional Patent Application hereby claims priority to and the full benefit of United States Non-provisional Application entitled “Media Code Systems and Methods,” having assigned Ser. No. 61/895,650, filed on Oct. 25, 2013, incorporated herein by reference in its entirety.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The instant disclosure is directed towards media advertisements and advertising, and more particularly to media code systems and methods for advertisements and advertising with such media code systems and methods.

2. Description of the Related Art

Most media advertising today relies on the consumer to remember a 10 digit phone number or lengthy website in order to gather more information or content about the advertiser. Often the consumer does not have an opportunity to record this information or remember it for a sufficient period in which to use it.

A potential customer may be unable to connect to a company advertising for direct sales for many reasons. These may include, but are not limited to: confusion or forgetting the connection address (telephonenumber or website where rarely is the website exactly the same name as the product and telephone numbers are typically too long to remember); reluctance to get in a telephone conversation knowing it might turn into a “selling situation” or require a tedious process of information transfer; the time between seeing the advertisement and the point when a purchase can be made is too long and the customer loses interest; people often see advertisements with easy access to their phone but the browsers are clumsy for navigating websites; the like; or combinations thereof.

In addition, advertisers do not have an easy way to determine what has lead a consumer to their website or call center. This makes it hard to optimize advertising strategies.

As a result, there is clearly an unmet need for new advertisements or advertisements that are easier to remember and/or easier to track. The instant disclosure may be designed to address at least one or all of these problems.

### SUMMARY

Briefly described, in select embodiments, the present disclosure of media code systems and methods may generally include a media code assigned to an advertisement. The media code may be a mnemonic code associated with the advertisement. A server may store the media code and content relative to the media code. Computer software may be in communication with the server for entering the media code and retrieving the content. Whereby, the media code system and method may provide a means for consumers to interact with the advertisement.

In one embodiment, the mnemonic media code may be a one to six digit code. In another embodiment, the mnemonic code may be a one to four digit code. The mnemonic media code may be associated with companies or products that eliminate the need to remember telephone numbers and/or website addresses.

One feature may be, when the media code is entered into the computer software, the computer software may return selection boxes with content picked by an advertiser of the advertisement. In select embodiments, the selection boxes may include: links to website; telephone numbers for immediate use; option for telephone numbers and/or website links texted or emailed to user for future; store hours; coupons; promotions; links to purchase forms or options; the like; or combinations thereof.

In select embodiments, the media codes may be purchased or leased by the advertiser and may be selected by the advertiser.

One feature may be that the content associated with the media code can be switched by the advertiser in real time.

In various embodiments, the advertisement may be a television, voice, print, billboard, scoreboard, the like, and/or advertisements with combinations thereof, or any interactive marketing, in person promotions, the like, etc.

Another feature may be that the server may host consumer information for making ordering streamlined and allowing a retailer to set up push to order links via the computer software. As examples, the consumer information may include: name, mailing address, shipping address, telephone number, email, payment information, seating, sex, sizes, birthday, seat number, online payment information, or combinations thereof.

Another feature may be that the push to order links may include a four step ordering process consisting of: purchase; agree to terms; ship to home; and web based payment.

In various embodiments, the computer software may be included on a website and/or smart phone application.

One feature of the computer software may be that it can provide for direct entry of the media code and/or means for locating the proper advertisement when the code is forgotten or unavailable. The computer software may provide direct entry via typing and/or voice entry, wherein the direct entry may include a prompt of “Please enter or speak the Media Code”. The means for locating the proper advertisement when the code is forgotten and/or unavailable may include a keyword search of advertisements having filters by parameters including, but not limited to: media type and location; time search filtered by media and station; general service provided filtered by time; media type; station; the like; and/or combinations thereof. In select embodiments, drop down picks may be presented as the search is narrowed.

Another feature of the server may be that it can record the product links and the time slots in which the advertisements appear.

Another feature of the server may be that it can record consumer input data for advertising analytics, including, but not limited to, which media outlet as well as the time slot and percentage of times a specific keyword or product search is used.

Another feature of the computer software may be that it can be programmed to automatically enter a user's address and link to third party sellers if the advertising is a wholesaler, as well to link to coupon or other retail offerings.

A method of advertising with media codes may include assigning a media code to an advertisement. The media code may be a mnemonic code associated with the advertisement. The method may further include creating content relative to the media code; storing the media code and content relative to the media code on the server; communicating with the server via a computer program; and/or entering the media code into the computer program and retrieving the content from the server. Whereby, the method may provide a means for consumers to interact with the advertisement.

These and other features of the media code systems and methods will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present media code systems and methods will be better understood by reading the Detailed Description with reference to the accompanying drawings, which are not necessarily drawn to scale, and in which like reference numerals denote similar structure and refer to like elements throughout, and in which:

FIG. 1 is a schematic diagram of the media code system according to select embodiments of the instant disclosure;

FIG. 2 is a flow chart diagram of the method of advertising with media codes according to select embodiments of the instant disclosure;

FIG. 3 is screen shots of the information capture for the computer program according to select embodiments of the instant disclosure;

FIG. 4 is a screen shot of the first for the computer program according to select embodiments of the instant disclosure;

FIG. 5 is screen shots of example selection boxes for the computer program according to select embodiments of the instant disclosure;

FIGS. 6A and 6B are screen shots of example selection boxes for the computer program according to select embodiments of the instant disclosure;

FIG. 7 is screen shots of example selection boxes for the computer program according to select embodiments of the instant disclosure;

FIG. 8 is screen shots of example selection boxes for the computer program according to select embodiments of the instant disclosure;

FIG. 9 is screen shots of example selection boxes for the computer program according to select embodiments of the instant disclosure;

FIG. 10 is screen shots of example selection boxes for the computer program according to select embodiments of the instant disclosure; and

FIGS. 11A and 11B are screen shots of example interactions for the computer program according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

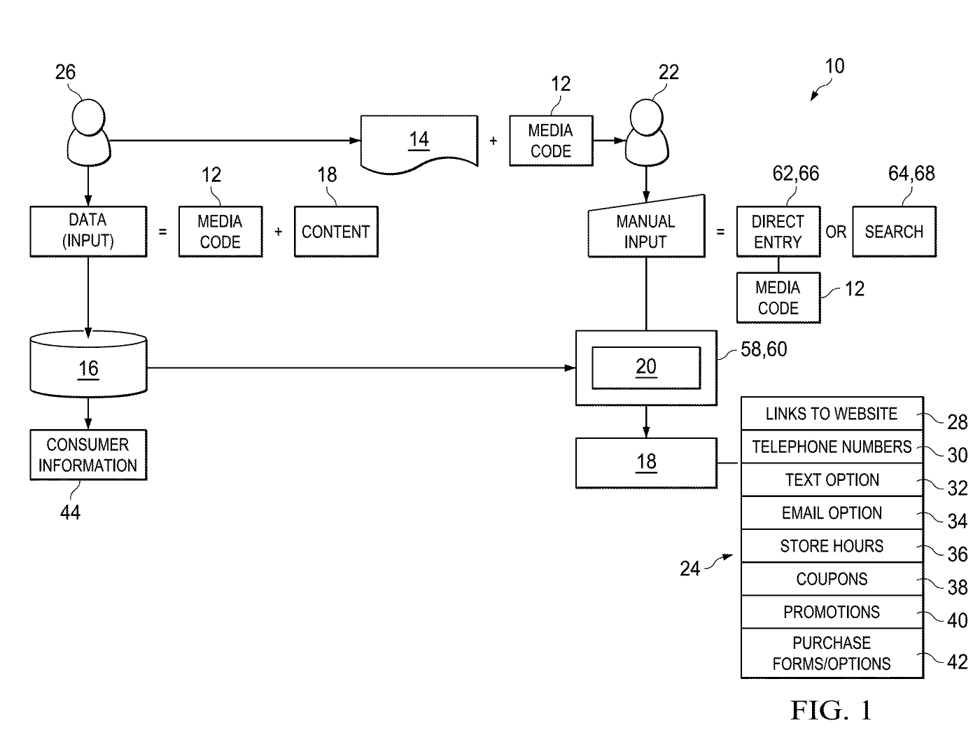

In describing the example embodiments of the present disclosure, as illustrated in FIGS. 1-11, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Exemplary methods may be conceived to be a sequence of steps or actions leading to a desired result and may be implemented as software. While it may prove convenient to discuss such software as if were embodied by a single program, most implementations will distribute the described functions among discrete (and some not so discrete) pieces of software. These pieces are often described using such terms of art as “programs.” “objects.” “functions.” “subroutines,” “libraries,” “.dlls.” “APIs.” and “procedures.” While one or more of these terms may find favor in the present description, there is no intention to limit the invention to the described configurations.

In general, the sequences of steps in the present methods require physical manipulation of physical quantities. These quantities take the form of optical, electrical or magnetic signals capable of being stored, transferred, combined, compared or otherwise manipulated. Those of ordinary skill in the art conveniently refer to these signals as “bits”, “values”, “elements”, “symbols”, “characters”, “images”, “terms”, “numbers”, or the like. It should be recognized that these and similar terms are to be associated with the appropriate physical quantities and are merely convenient labels applied to these quantities.

With respect to the software described herein, those of ordinary skill in the art will recognize that there exist a variety of platforms and languages for creating software for performing the methods outlined herein. Those of ordinary skill in the art also recognize that the choice of the exact platform and language is often dictated by the specifics of the actual system constructed, such that what may work for one type of system may not be efficient on another system. It should also be understood that the methods described herein are not limited to being executed as software on a computer or DSP (Digital Signal Processor), but may also be implemented in a hardware processor. For example, the methods may be implemented with HDL (Hardware Design Language) in an ASIC.

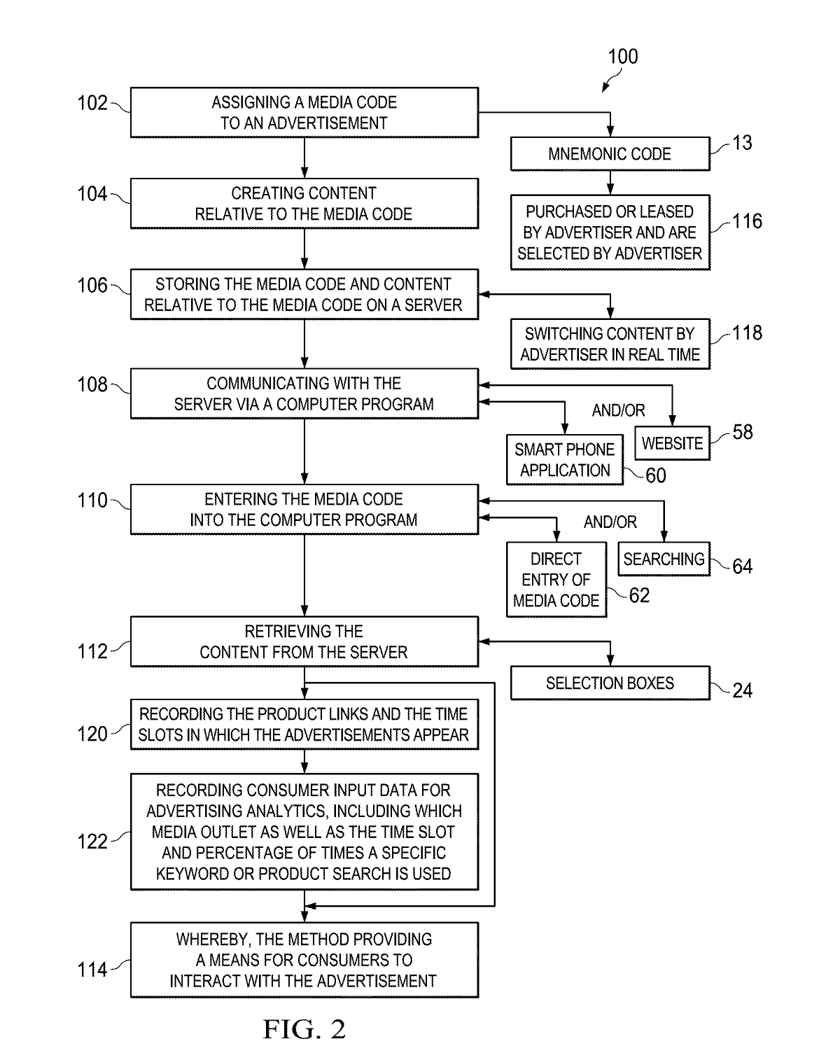

The instant disclosure is directed toward media code systems and methods. Referring now to FIGS. 1 and 2 by way of example, and not limitation, therein is illustrated example embodiments of media code system 10 in FIG. 1 and method 100 of advertising with media codes in FIG. 2. Media code system 10 and method 100 may provide a fast and easy way for consumers and advertisers to connect using a computer program like on a website or on their phone.

Referring now specifically to FIG. 1, media code system 10 may generally comprise media code 12 assigned to advertisement 14. Media code 12 may be any desired media code. In one embodiment, media code 12 may be mnemonic code 13 associated with advertisement 14. In other words, media code 12 may be mnemonic code 13 that is easy to remember with advertisement 14. Server 16 may be included for storing media code 12. In addition, server 16 may store content 18 relative to media code 12. Computer software 20 may be included in system 10 and may be in communication with server 16. Computer software 20 may be for entering media code 12 and retrieving content 18 from server 16. Whereby, media code system 10 may provide a means for consumers 22 to interact with advertisement 14.

Media code 12 may be provided along with advertisement 14 for consumers 22 to be remembered and inputted into computer software 20. Media code 12 may be any desired code of letters, numbers, symbols, the like, etc. In one embodiment, media code 12 may be mnemonic code 13 that may be a one to six digit code of letters, numbers, symbols, the like, etc. In another embodiment, media code 12 may be mnemonic code 13 that may be a one to four digit code letters, numbers, symbols, the like, etc. Mnemonic code 13 may be is associated with companies or products that eliminate the need to remember telephone numbers and/or website addresses.

When media code 12 may be entered into computer software 20, computer software 20 may return selection boxes 24. The content 18 of selection boxes 24 may be picked by an advertiser 26 of advertisement 14. As such, selection boxes 24 may be any desired number or type of selection boxes for advertiser 26 and may include any desired content 18. For example, and clearly not limited thereto, selection boxes 24 may include: links to website 28; telephone numbers for immediate use 30; text option 32 for telephone numbers and/or website links texted for future; email option 34 for telephone numbers and/or website links emailed for future; store hours 36; coupons 38; promotions 40; links to purchase forms or options 42; or combinations thereof. In an example embodiment, media codes 12, when entered into computer program 20 may, among other operations, link to the product's website, send telephone numbers to a mobile device, and provide links for purchasing options. The website may be programmed to automatically enter a user's address and link to third party sellers if the advertising is a wholesaler, as well to link to coupon or other retail offerings.

Media codes 12 may be created for use in media code system 10. Media codes 12 may be created or assigned by any means. In one embodiment, media codes 12 may be purchased or leased by advertiser 26 of advertisement 14 and, as such, may be selected by advertiser 26 of advertisement 14.

Server 16 may store media code 12 and the relevant content 18. The relevant content for each media code may be created and uploaded onto server 16 by advertiser 26. In one embodiment, content 18 can be switched by advertiser 26 in real time on server 16. This may allow content 18 to be dynamic and change at any time or desire of advertiser 26.

Advertisement 14 may be provided to consumer 22 with media code 12. Advertisement 14 may be any desired form of advertisement or media, including, but not limited to, a television, voice, print, billboard, scoreboard, the like, and/or any advertisement with combinations thereof, or any interactive marketing, in person promotions, the like, etc.

Server 16 may also host or store consumer information 44. The consumer information 44 hosted on server 16 may be any desired consumer information. Consumer information may be for making ordering streamlined and allowing a retailer to set up push to order links via computer software 20. Consumer information 44 may include, but is not limited to, name, mailing address, shipping address, telephone number, email, payment information, seating, sex, sizes, birthday, seat number, online payment information, the like, or combinations thereof. For example, the push to order links may include a four step ordering process consisting of: purchase; agree to terms; ship to home; and web based payment. In select embodiments, computer software 20 may store returned information on the server via email or text.

Computer software 20 may be any type of computer software and may be used on any computer or like device. In select embodiments, computer software 20 may be hosted on website 58 and/or smart phone application 60. Computer software 20 may allow entry of media code 12 for retrieving relevant content 18 from server 16. Computer software 20 may provide for direct entry 62 of media code 12 and/or means 64 for locating the proper advertisement when the code is forgotten or unavailable. Direct entry 62 may be via typing and/or voice entry. Direct entry 62 may include any means for direct entry including, but not limited to, a prompt of “Please enter or speak the Media Code”. In an example embodiment, the website may receive a direct code entry as the first point of contact with the user, for example, by interface with a computer, tablet, smart phone, or the like. Non-limiting examples of direct code entry methods include keystroke and voice command. Means 64 for locating the proper advertisement when the code is forgotten and/or unavailable may include any means for looking up advertisement 14. In one embodiment, means 64 may include a keyword search of advertisements having filters by parameters including, but not limited to: media type and location; time search filtered by media and station; general service provided filtered by time; media type; station; or combinations thereof. In select embodiments of means 64, drop down picks may be presented as the search is narrowed.

In an example implementation, a direct retail advertisement is played on the radio, offering a limited time 10% discount. The advertisement 14 may include the standard production with a trailer stating media code 12, which could be in addition to or take the place of the telephone number and/or website. For example, a plumbing service presents the following advertisement: For Speedy

Plumbers please call 888-579-7655, visit speedyplumbers.com, or use media code SP1. The consumer 22 can access the advertiser's information three different ways depending on which method they prefer or remember from the advertisement. Once the consumer hears/sees the code 12, she can enter it through one or more ways, including through computer software 20, like website 58 or a phone app 60, among others.

For website 58 entry, the consumer visits a particular URL and finds a prompt, which may read something like “Please enter or speak the Media Code”. The consumer then enters “SP1”. This may then link to Speedy Plumber's website and special offer, for example. In an example embodiment, the website 58 may provide additional information with minimal effort on the consumer's part to the business, such as the customer address, as a non-limiting example.

For smart phone application 60, again, a prompt may be presented to the consumer, such as “Please enter or speak the Media Code”. The consumer then enters “SP1.” In an example embodiment, an email is sent with link

Speedyplumbers.com to the consumer's email address perhaps with additional links for directions or to special offers, such as a non-limiting example of a 10% off coupon. Additionally, Speedy Plumber's telephone number may be sent via text to the customer's smart phone. This allows the customer to call by pressing the link or to locate the business by following the email link and directions link.

If the consumer cannot remember media code 12 (or it is unavailable for whatever reason), a list of advertisements 14 by Radio Station and time may be searched. Many search engine algorithms or processes may be implemented. In an example embodiment, the consumer 22 may select the radio station they were listening to and look for advertiser 26 in a time slot in which she was listening. The advertisements 14 for that time slot may be listed for her selection.

For example, computer program 20, like website 58, or other interface, prompts with “Please Pick Radio Station” and the consumer enters 98.7 Atlanta. Computer program 20 then prompts “Please enter time slot” and the consumer enters “8 am-8:30 am” for example. The computer program 20 may then return a list of advertisements 14 that were presented during that time slot.

The interface of computer program 20 may return:

8:00—Pete's travel agency—deals to Italy

8:02—ACME Hardware—Garden month—vegetable offer

8:04—Speedy Plumbers—10% discount

The consumer 22 may then click on the Speedy Plumbers link and the interface of computer program 20 may give more information related to advertiser 26, for example, computer software 20 may take consumer 22 to the Speedy Plumbers website and can provide the consumer's information if desired.

In another example embodiment, consumer 22 can search a list of services through the interface of computer software 20. The consumer 22 may, for example, visit website 58 and/or utilize cell phone app 60 to filter a list of services by city and type of advertisement (TV, radio, print, etc.) of the service.

For example:

“Please enter largest city in area”=Atlanta

“Please enter Media Type”=Radio

“Please enter keyword”=plumber

The computer program 20 may then return appropriate links, for example, Speedy Plumbers—10% discount. The consumer 22 may then click the link and is taken to the website where additional information is available. The search may produce data capture such as time slot and type of media that delivered advertisement 14.

In another example, a wholesaler may run advertisement 14 on television, such as, for example, Full Ink Pen's “Never Leak”. At the end of advertisement 14, media code NL5 is presented. Media code NL5 may then be entered into computer program 20, like website 58 and/or smart phone application 60.

For website 58 entry of the code, the consumer may be prompted with “Please enter or speak the Media code” to which consumer 22 may enter “NL5”. This may link to, for example, Full Ink's website; any special coupons; and a link to retail offers. For example, Large Pharmacy Chain's link may be presented for quick order or coupon printing for smart phone coupon.

For media code 12 entry through smart phone application 60, after entry of the code in the app, a link may be sent to consumer's email with Full ink's website; any special coupons; and/or a link to retail offers. Offers may be have ability for auto-fill of shipping information of online orders for quick completion (retailers may compete for placement or maybe chosen by wholesaler).

If media code 12 is not remembered or inaccessible, advertisement 14 may be searched by television station advertisements and times.

For website search:

“Please enter Largest city”=Atlanta

“Please enter media type”=TV

“Please enter cable network”=Fast Cable

“Please enter station”=387/daytime reality

“Please enter time slot”=2 pm-2:30 pm

“Please pick”: Select between “ALL ADS” and “LIST OF PRODUCTS OR SERVICES”

If “ALL ADS” is chosen, all advertisements that use media code 12 may be displayed as links and, again, provide all the consumer information that can be shared.

2:00—Quick Dry mops—QD2

2:02—Full Ink Pen's—Never Leak Pen—Large pharmacy chain offer—NL5

2:04—Joe's All Natural Health Bar—JHB1

If “LIST OF PRODUCTS OR SERVICES” is chosen, then the list may be provided:

Mops—Quick Dry—QD2

Pen—Never leak—NL5

Health bars—Joe's Health Bar—JHB1

Computer software 20 may also be programmed to automatically enter a user's address and link to third party sellers if the advertising is a wholesaler, as well to link to coupon or other retail offerings.

Server 16 may record any other relevant or desired data for advertisement 14 and/or consumer 22. In one embodiment, server 16 may record the product links and the time slots in which the advertisements appear. In another embodiment, server 16 may record consumer input data for advertising analytics, including which media outlet as well as the time slot and percentage of times a specific keyword or product search is used. A service of media code system 10 may be responsible for working with the advertisers 26 and media outlets to record the product links and the time slots in which the advertisements appear. As consumers use media code 12 there may be numerous points where data may be captured. This data may be used to determine the effectiveness of the advertising strategy.

Referring now to FIG. 2, method 100 of advertising with media codes 12 generally includes a step 102 of assigning media code 12 to advertisement 14. As discussed above, media code 12 may be any desired media code, including a mnemonic code 13 associated with advertisement 14 that may be easier to remember than telephone numbers and/or websites. Method 100 of advertising with media codes 12 may also include: step 104 of creating content 18 relative to media code 12; step 106 of storing media code 12 and content 18 relative to media code 12 on server 16; step 108 of communicating with server 16 via computer program 20; step 110 of entering media code 12 into computer program 20; and step 112 of retrieving content 18 from server 16. Whereby, method 100 may provide a means for consumers 22 to interact with advertisement 14.

Method 100 of advertising with media codes 12 may include any steps or methods of utilizing system 10 as shown and/or described herein. In select embodiments, method 100 may also include step 116 of advertiser 26 purchasing or leasing media code 12. In another embodiment, method 100 may include a step 118 of switching content 18 in real time by advertiser 26. In another embodiment, step 120 of recording the product links and the time slots in which the advertisements appear on server 16 may be included. In yet another embodiment, step 122 may be included of recording on server 16 consumer input data for advertising analytics, including which media outlet as well as the time slot and percentage of times a specific keyword or product search is used.

Media code system 10 and method 100 of advertising with media codes 12 may include computer program 20, like central website 58 and/or mobile device application 60, that provides the fastest and easiest way for people to interact with advertising over any media (television, voice, print, billboard, scoreboard, interactive marketing, in person promotions, the like, etc). Computer program 20 along with server 16 may host short easy to remember 1-4 digit media codes 12 that are associated with advertisers 26 or product advertisements 14. The codes 12 can be purchased or leased and may be selected by the client or advertiser 26. Codes 12, when entered, may return selection boxes 24, like one to six selection boxes 24, with content 18 picked by the client or advertiser 26. This content 18 can be switched quickly and easily. Examples of selection boxes 24 may be, but are not limited to: touch to connect links to website or telephone numbers (for immediate use or texted or emailed to user for future), store hours, coupons, promotions, links to purchase forms, the like, or combinations thereof. System 10 will host consumer information (like addresses, phone number, email, payment information, seating, sizes) making ordering streamlined and allow a retailer to set up push to order links. Such push to order links may potentially consist of a four click ordering: 1) purchase; 2) agree to terms; 3) ship to home; and 4) web based payment. Media codes 12 may eliminate the need to remember telephone numbers or website addresses and may be easier to use. System 10 and method 100 may make connection fast, easy, and convenient and may store returned information via email or text.

The potential consumers 22 and uses of media code system 10 and method 100 may be unlimited, including, but not limited to: retail product offerings, like with quick easy to remember access point and ability to build link with retailer for direct ordering with stored data for one touch selection, ability to enter code real time and use the information later through text messages and emails, and/or also one push information, like website, directions, store hours; television networks, like with partnerships with advertisers and producers, interactive commercial content/real time promotions, which may increases commercial viewership and allow active participation in questions asked during breaks; wholesale product offering, like potential partnering with retailer allowing direct ordering or one push information, like website, directions (text, image, or video), and/or investor links; and/or sporting events, concerts, large gatherings, like with push button security, ability to run contests, voting, polls, collect data, call for service, easily changeable data base for real time changes to content, and/or set to hold seat number to make data transfer completely push button.

In an example embodiment, method 100 of advertising with media codes 12 on one or more types of media (television, radio, print, billboards, signs, interactive media, in person promotions, and other) may be made more effective by providing a short, easy to remember code of letters and/or numbers that may be input to central server 16 in communication with computer program 20 (for example, a website) through computer and/or smart phone applications. Computer program 20 may provide for direct code entry and have a variety of other ways to locate the proper advertiser's product from the provided code. As a result, the website may be advertised so it becomes a familiar household name. Input through smart phone applications may allow for real-time entry making it easy to use for immediate ordering or locating of a business. In an example embodiment, the code may be input through voice entry, which will allow for real time use as the advertisements are viewed/heard.

Over time media code 12 may become synonymous or linked with the brand in the mind of consumer 22, which may make advertising much more effective. Additionally, data may be recorded for which media outlet (radio station, Television station) as well as the time slot and percentage of times a specific keyword or product search is used. This may help to target advertising strategies and determine the effectiveness of the current media code 12 or other keywords in the advertisement.

The media codes 12 may be generated with the input of the advertising companies 26. In general, they would be short enough to be remembered easily and be related to the company's name or the product name. In an example embodiment, Speedy Plumbing could have a code of SPx where x is the number of the particular advertisement 14 in a series of advertisements. Likewise, an advertisement 14 for Quick Dry Mops may be QDx, for Never Leak product may be NLx, and for Joe's All Natural Health Bar may be NHBx.

The media code system 10 and methods 100 may be marketed to advertising companies 26. The fees may be both fixed and variable. The fixed fee component may secure the media code 12 for a negotiated length of time and the variable fee may be based on media used and the number of times it appears.

Media code system 10 and methods 100 may be designed to make all forms of advertising more effective (TV, radio, print, billboard, score board, announcements, interactive media, in person promotions, the like, etc). The media code smart phone application 60 may be in communication with a data base or server 16 that allows push button selection of a variety of content 18 picked by an advertiser 26. This content 18 may already be owned and maintained by the client (websites, telephone numbers, store hours, etc) although it also can be interactive content (polling, trivia, voting, direct order forms, calls for security, etc). The data base or server 16 may store individual consumer information (email, telephone number, mailing/shipping address, name, birthdate, sex, size, seat number, online payment system, etc). This information will be easily pushed/pulled or linked to advertiser's 26 content 18. This may facilitate and make ordering, registering, summoning, or calling substantially faster than having to enter it manually. In addition media code system 10 and methods 100 can return data to the user via email or SMS (text) messaging. These features may make it useable at a later date and easily located. The data base or server 16 may be easily changeable (real time) and can be used to offer limited time entry or offers, provide links to new data (videos, statistics, photos), or provide answers to trivia etc after a set time.

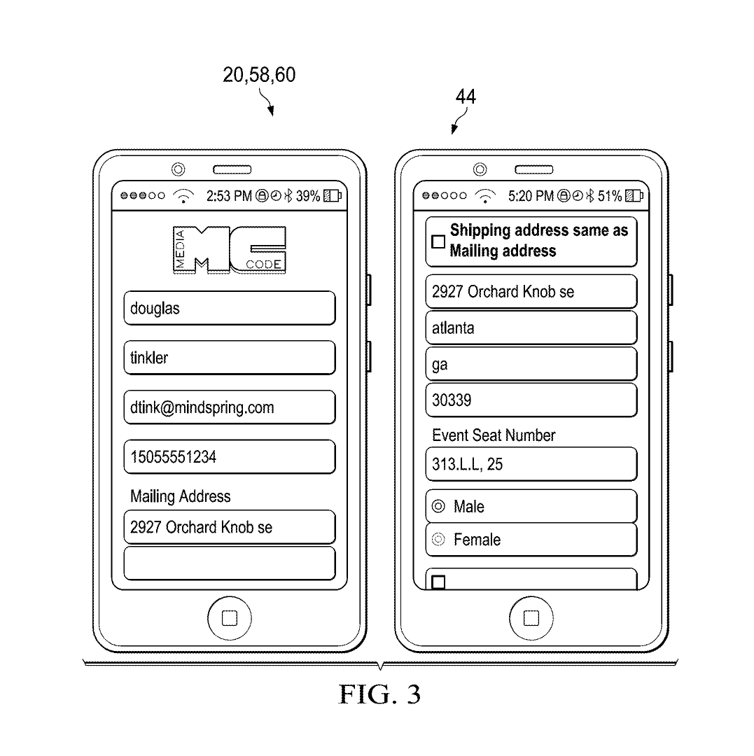

Referring now to FIG. 3, example introduction screens for information capture of consumer 22 of computer program 20 is shown.

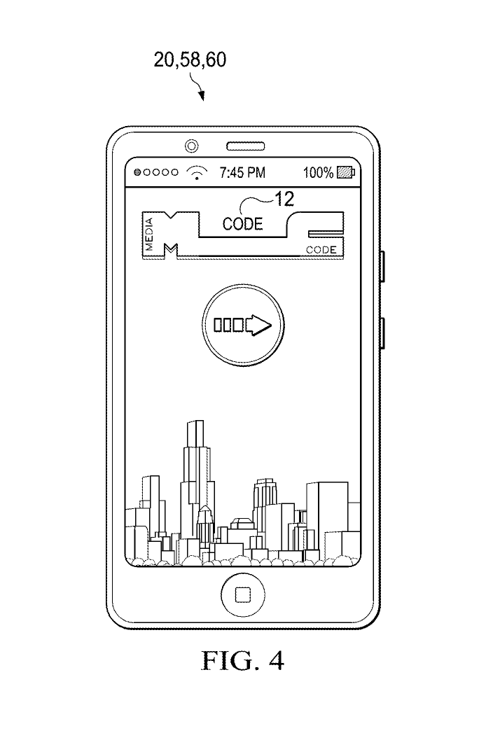

Referring now to FIG. 4, an example first screen after the consumer's information is captured is shown. In this screen, the consumer can enter media code 12 and hit the arrow to retrieve the content 18.

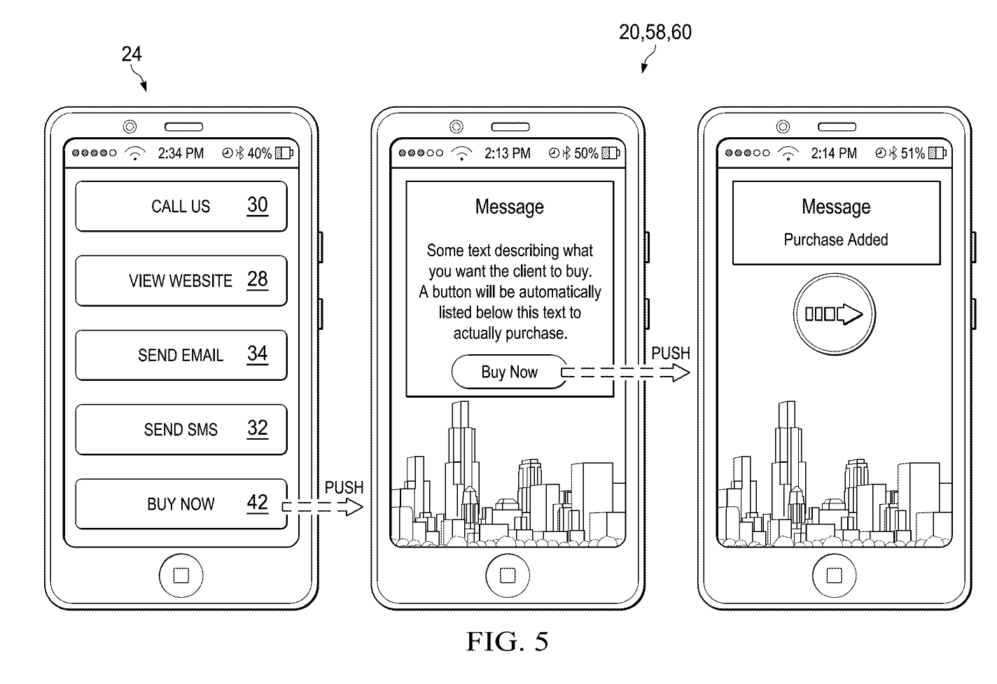

Referring now to FIG. 5, example selection boxes 24 is shown for computer program 20. The selection boxes 24 may be accessed by media code 12 of one to six letter and/or numbers and symbols (selected by the advertiser 26). Given the ability to use a short code that is related to the client or product it is assumed it will be easier to remember than websites or telephone numbers. In general phone browsers do a poor job on websites and often users only want specific information on the website. Having this information available in push button format may be a big improvement. In addition advertising is static and hard to remember. Media code system 10 and methods 100 may provide interaction opportunities that may make advertising more effective which may be short and easy to remember. The data returned to the user will often be in the form of links (telephone, website, etc) so it can be pushed to use.

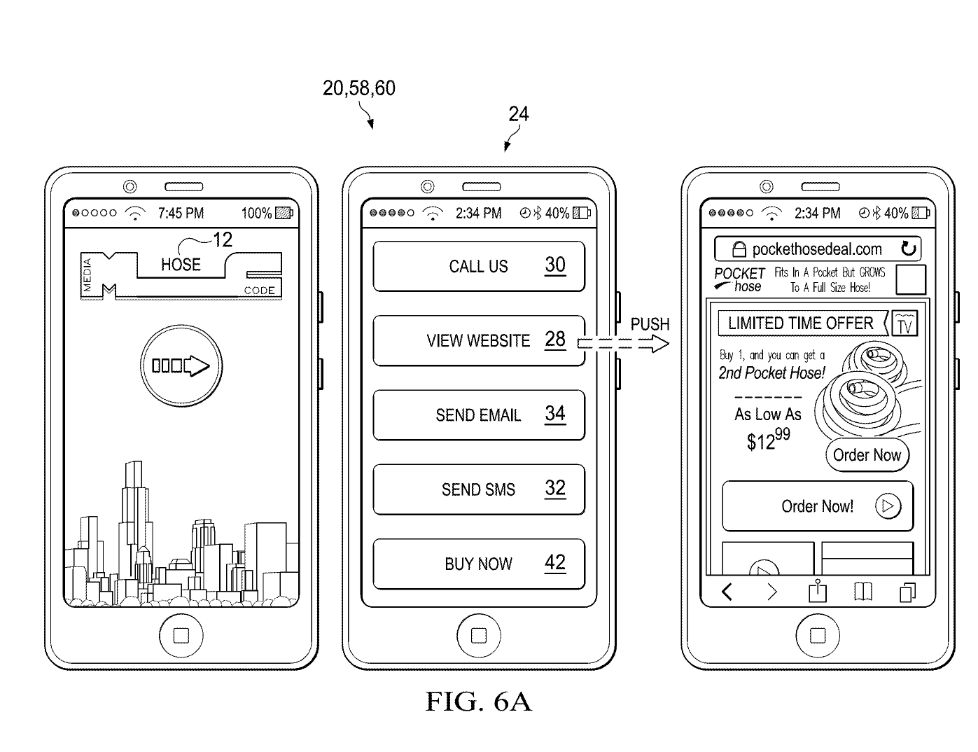

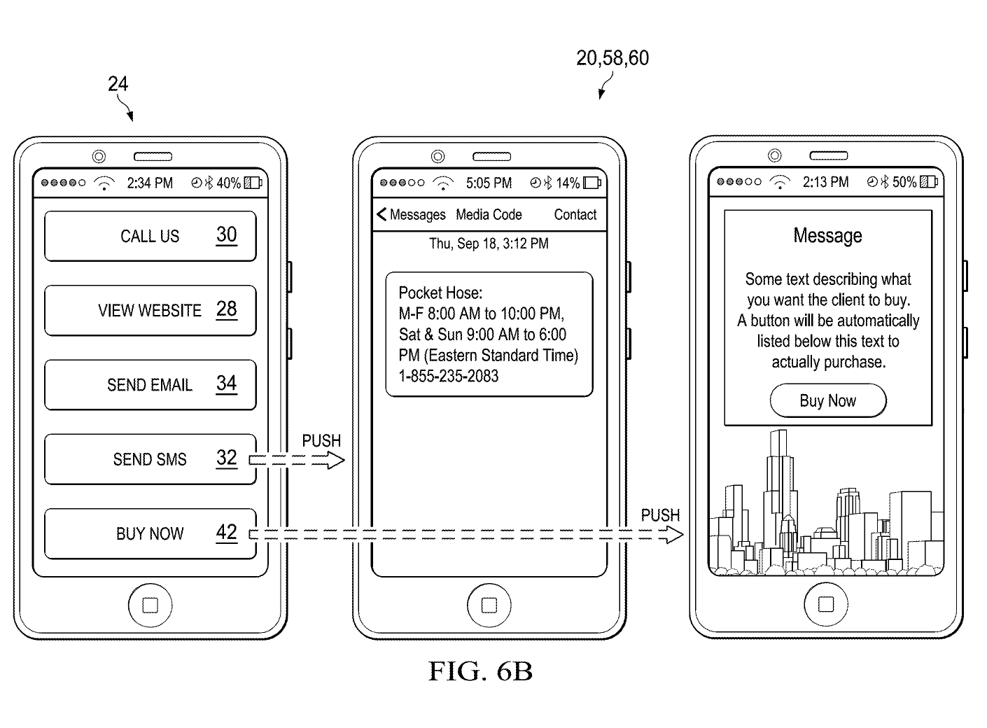

Referring now to FIGS. 6A-6B, the instant disclosure contemplates media code systems 10 and methods 100 being used by clients to run promotions, push directions, link multiple company or advertisements or shows, send special offers, offer discounts, etc. As shown in this example, for direct advertising: Pocket Hose television advertisement does a great job selling the product then asks the customer to—Calll-855-235-2085 or www.pockethosedeal.com. As should be readily understood, the phone number is long and hard to remember and having operators waiting is not inviting. In addition, the website is not the exact product name. As such, media code system 10 and methods 100 may provide a better way to connect, i.e. to use Media Code “Hose”. An SMS button may be selected, phone number (push to dial link), and/or hours may be sent via text for immediate or future use. In addition, the website button may go to website in browser, and the buy now may push stored info and completes order.

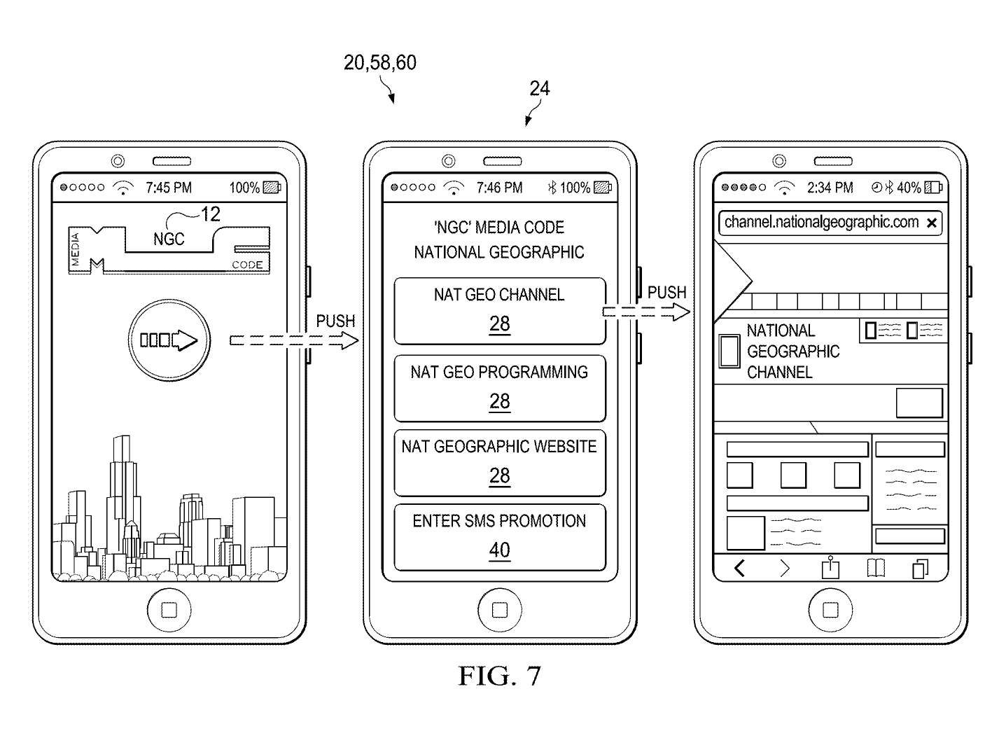

Referring now to FIG. 7, the instant disclosure of media code system 10 and methods 100 contemplates an example of a network code: National Geographic Channel main page. In this example embodiment, once the consumer 22 enters “NGC” and pushes the arrow, the second screen appears with selection boxes. Once the top box is pushed of NAT GEO CHANNEL, the consumer may be connected to the home page on an internet browser.

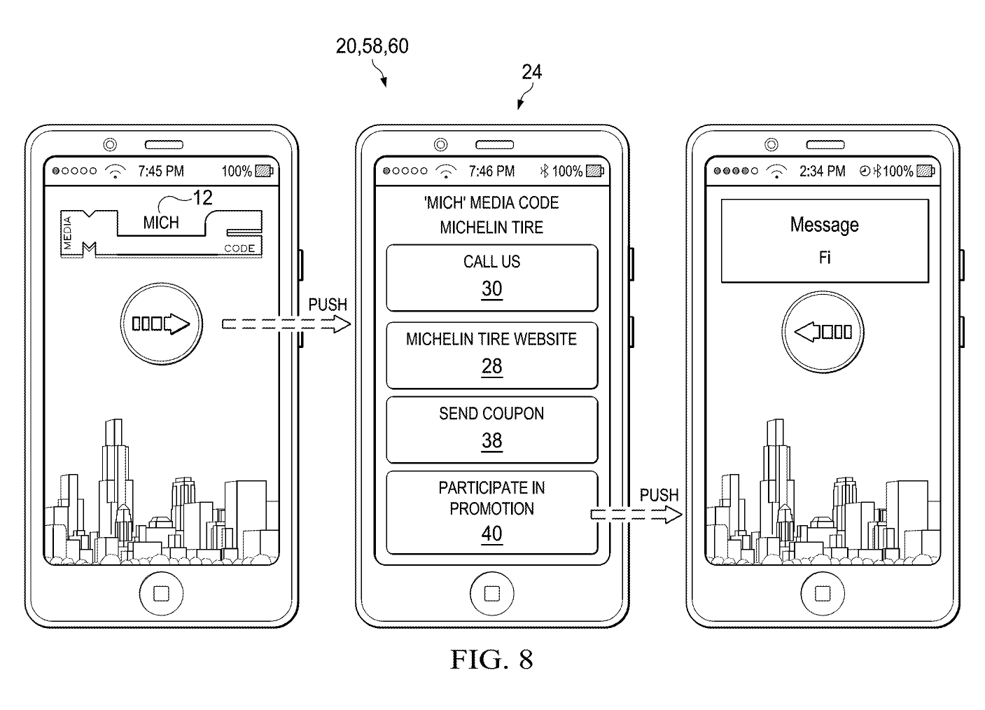

Referring now to FIG. 8, the instant disclosure of media code system 10 and methods 100 contemplates an example Michelin main page and promotion message. In this example embodiment, the consumer 22 may enter “MICH” and push the arrow. The second screen appears with selection boxes where they pushed the bottom button of “PARTICIPATE IN PROMOTION” and the promotion for “Fi” appears.

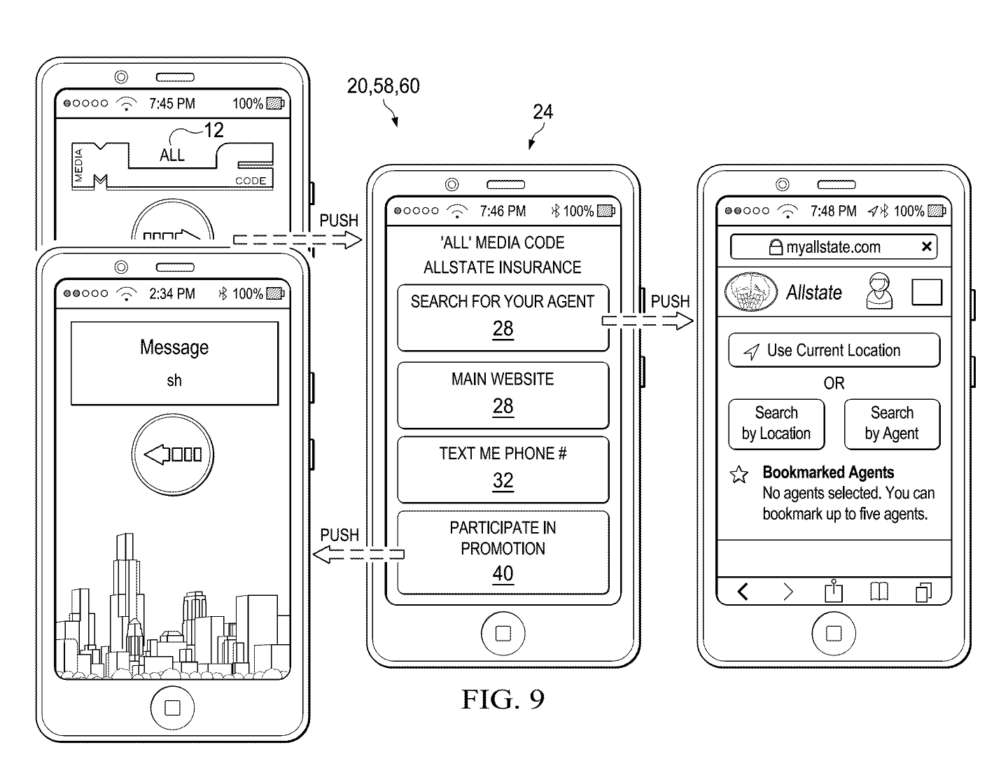

Referring now to FIG. 9, the instant disclosure of media code system 10 and methods 100 contemplates an Allstate Insurance example. In this example embodiment, the consumer 22 pushes for the specific portion of the website “SEARCH FOR YOUR AGENT” and “PARTICIPATE IN PROMOTION”. The consumer 22 first enters “ALL” and pushes the arrow. Allstate's selection box page then appears. The consumer 22 then selects bottom box for “PARTICIPATE IN PROMOTION″and “sh” is revealed. The consumer 22 may also select top box “SEARCH FOR AGENT” and is taken to a specific part of Allstate's website.

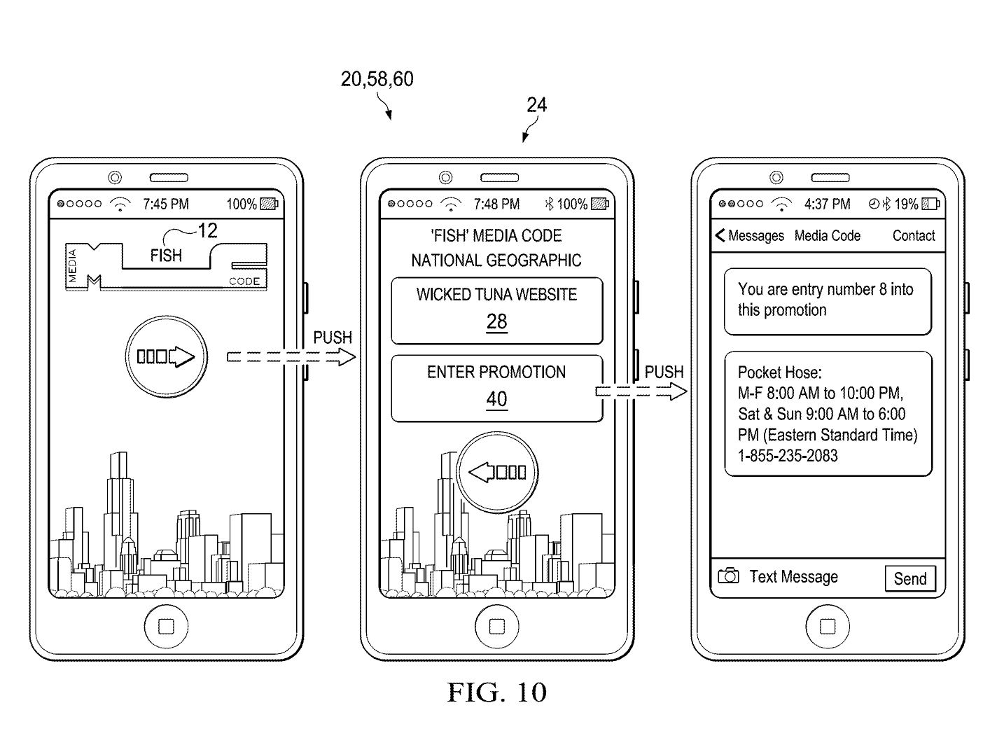

Referring now to FIG. 10, the instant disclosure of media code system 10 and methods 100 contemplates an example of entering returned codes which leads to promotion entry. In this example embodiment, the consumer 22 enters the “FISH” code revealed in two media code interactions. The Fish selection box screen appears. The consumer 22 selects the bottom button of “ENTER PROMOTION” and a text message is sent to their phone confirming the entry with number.

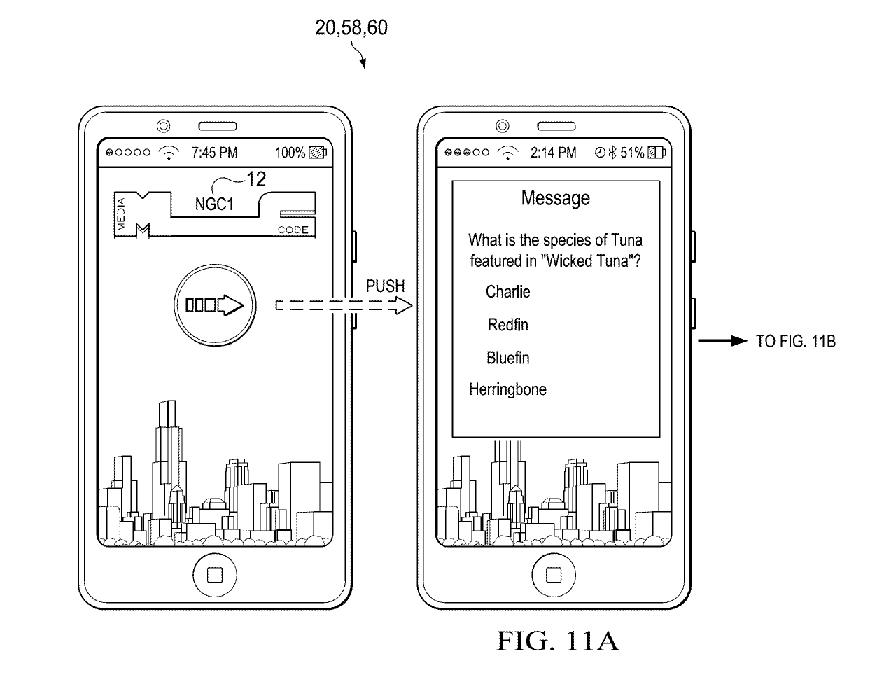

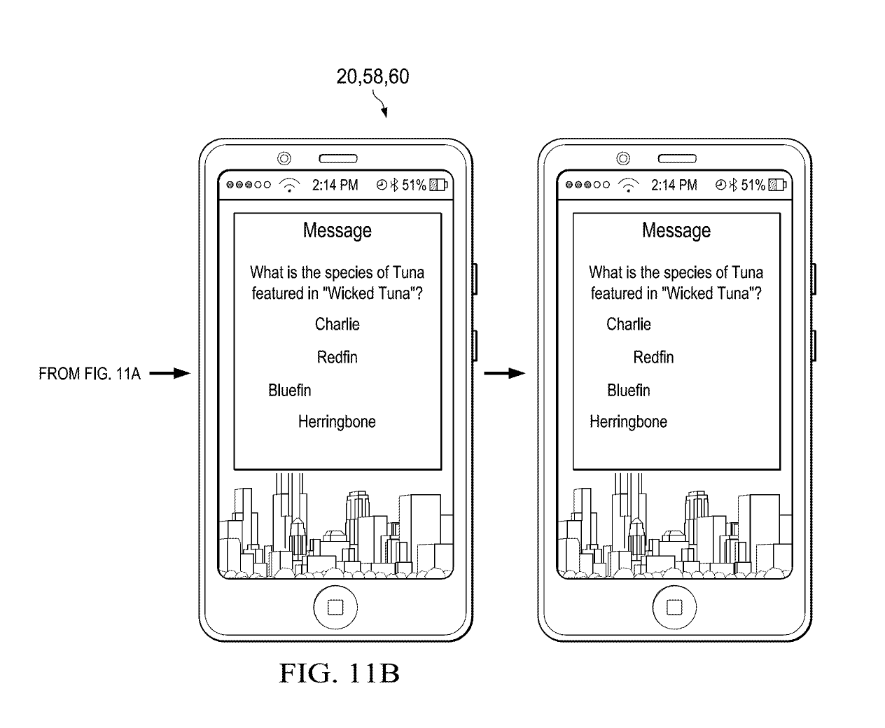

Referring now to FIGS. 11A-11B, the instant disclosure of media code system 10 and methods 100 contemplates a National Geographic secondary code with an interactive question with answers revealed after selection.

The instant disclosure of media code system 10 and methods 100 also contemplates television commercials compete with a variety of sources. DVR usage has increased dramatically over the recent years. One study found 94% of television viewers were multitasking during viewing, where 60% of viewers were using their smart phone. Even the Last Channel button makes it less likely commercials will be watched. A study found on-line advertisements had better brand retention for viewers and interaction increases retention. As such, media code system 10 and methods 100 can turn a television into an interactive experience. Since 60% of people already watch television with their smart phones it makes sense they could be persuaded to use it to interact with the content. Media code system 10 and methods 100 can be tailored real time to reward the actual viewers of television content during the primary broadcast time slot like in commercials or programing. The reward system can come in a variety of avenues: coupons, contest applications, guest appearances, prizes, the like, etc. As such, media code system 10 and methods 100 could make for a great partnership opportunity between advertiser, network, and content production.

The instant disclosure of media code system 10 and methods 100 also contemplates promotion using media codes 12. For example, advertisements for an upcoming reality television show, like Watch Wicked Tuna for a chance to appear on the show, or download the smart phone application 60 to your smart phone. For example, media code 12 could be revealed during two commercials. Each company's media code 12 could be used to retrieve the letters and wait for instructions following the show. As another example, during the first set of advertisements the media code 12 for Michelin Tire Mich may be announced with directions to go to participate in promotion button. As a result, it may return letter “Fi” (promotion box may be up for a limited time). During the next set of advertisements media code 12 for Allstate Insurance ALL may be announced with directions to go to participate in promotion button. As a result, it may returns letter “sh” (promotion box is up for a limited time). After the show the producer of Wicked Tuna may come on and say enter the code retrieved earlier (Fish) into media code computer program 20 and push enter promotion (promotion box is up for a limited time), which may register consumer 22 for drawing. This may benefit advertisers 26 by encouraging consumers 22 to participate as consumers 22 must watch commercials, interact with advertisers and show, all in real time. As a result, using media code systems 10 and/or methods 100 may be more efficient than using other social media. It also allows partnership with advertisers and has viewers using the advertiser's, the network's, and/or the shows' media codes. This may make it more likely they will use one of the other selections to interact for reasons other than the promotion.

The foregoing description and drawings comprise illustrative embodiments. Having thus described example embodiments, it should be noted by those skilled in the art that the within disclosures are example only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A media code system comprising:
a media code assigned to an advertisement;
said media code being a mnemonic code associated with said advertisement;
a server for storing said media code and content relative to said media code;
and computer software in communication with said server for entering said media code and retrieving said content;
whereby, said media code system providing a means for consumers to interact with said advertisement.

2. The media code system of claim 1 wherein said mnemonic code being a one to six digit code that is associated with companies or products that eliminate the need to remember telephone numbers and/or website addresses.

3. The media code system of claim 1 wherein, when said media codes being entered into said computer software, said computer software returning selection boxes with content picked by an advertiser of said advertisement.

4. The media code system of claim 3 wherein the selection boxes being selected from the group consisting of: links to website; telephone numbers for immediate use; text option for telephone numbers and/or website links texted to user for future; email option for telephone numbers and/or website links emailed to user for future; store hours; coupons; promotions; links to purchase forms or options; or combinations thereof.

5. The media code system of claim 3 wherein the content can be switched by said advertiser in real time.

6. The media code system of claim 1 wherein said server will host consumer information for making ordering streamlined and allowing a retailer to set up push to order links via said computer software.

7. The media code system of claim 1 wherein said computer software being a website and/or smart phone application.

8. The media code system of claim 1 wherein said computer software providing for a direct entry of said media code and/or a means for locating the advertisement when the media code is forgotten or unavailable.

9. The media code system of claim 8 wherein said computer software providing said direct entry via typing and/or voice entry, wherein said direct entry including a prompt of “Please enter or speak the Media Code”.

10. The media code system of claim 8 wherein said means for locating the proper advertisement when the media code is forgotten and/or unavailable including a keyword search of advertisements having filters by parameters including:
media type and location;
time search filtered by media and station;
general service provided filtered by time;
media type;
station; or
combinations thereof;
wherein drop down picks may be presented as the search is narrowed.

11. The media code system of claim 1 wherein said server recording product links and time slots in which the advertisements appear.

12. The media code system of claim 1 wherein said server recording consumer input data for advertising analytics, including which media outlet as well as the time slot and percentage of times a specific keyword or product search is used.

13. A method of advertising with media codes comprising:
assigning a media code to an advertisement, said media code being a mnemonic code associated with said advertisement;
creating content relative to said media code
storing said media code and content relative to said media code on said server;
communicating with said server via a computer software;
entering said media code into said computer software; and
retrieving said content from said server;
whereby, said method providing a means for consumers to interact with said advertisement.

14. The method of advertising with media codes of claim 13 wherein said mnemonic code being a one to six digit code that is associated with companies or products that eliminate the need to remember telephone numbers and/or website addresses.

15. The method of advertising with media codes of claim 13 wherein, when said media codes being entered into said computer software, said computer software returning selection boxes with content picked by an advertiser of said advertisement.

16. The method of advertising with media codes of claim 15 wherein said media codes being purchased or leased by said advertiser and are selected by said advertiser.

17. The method of advertising with media codes of claim 16 wherein the content can be switched by said advertiser in real time.

18. The method of advertising with media codes of claim 13 wherein said computer software being a website and/or smart phone application.

19. The method of advertising with media codes of claim 13 wherein said computer software providing for a direct entry of said media code and/or a means for locating the proper advertisement when the code is forgotten or unavailable;
wherein said computer software providing said direct entry via typing and/or voice entry, wherein said direct entry including a prompt of “Please enter or speak the Media Code”; and
wherein said means for locating the proper advertisement when the code is forgotten and/or unavailable including a keyword search of advertisements having filters by parameters including:
media type and location;
time search filtered by media and station;
general service provided filtered by time;
media type;
station; or
combinations thereof.

20. The method of advertising with media codes of claim 13 wherein:
said server recording the product links and the time slots in which the advertisements appear;
said server recording consumer input data for advertising analytics, including which media outlet as well as the time slot and percentage of times a specific keyword or product search is used; or
combinations thereof.
